(19) United States
(12) Patent Application Publication
(10) Pub. No.: US 2009/0209682 A1
(43) Pub. Date: Aug. 20, 2009

(54) Use of an organic additve for producing porous concrete

(76) Inventors: Bernhard Sturm, Palling (DE); Konrad Wutz, Trostberg (DE)

Correspondence Address: FULBRIGHT & JAWORSKI, LLP, 666 FIFTH AVE, NEW YORK, NY, 10103-3198, US

(21) Appl. No.: 11/988,597

(22) PCT Filed: Jul. 17, 2006
(86) PCT No.: PCT/EP2006/007024

§ 371 Date: Jan. 10, 2008

(30) Foreign Application Priority Data
Jul. 18, 2005 (DE) 10 2005 033 454.7

(51) Int. Cl. C04B 38/00

(52) U.S. Cl. 524/4; 106/677; 106/642

(57) ABSTRACT

In order to produce porous concrete, the use of an organic additive with water-reducing, dispersing and/or flowability-increasing properties is provided. This additive is at least one representative of the series of polycondensation products based on naphthalinsulfonic acids or alkylnaphthalinsulfonic acids, melamine-formaldehyde resins containing sulfonic acid groups, and copolymers based on unsaturated mono- or dicarboxylic acid derivatives and on oxyalkylene glycol-alkenyl ethers. This additive is preferably admixed to a non-foamed and, in particular, mixing water-free porous concrete base mix containing lime, a hydraulic binder, preferably cement and sand, whereby quantities between 0.01 and 10% by weight are considered as preferred quantities. By using the additive in the aforementioned manner, the method for producing porous concrete can be carried out using distinctly less energy and thus more cost-effectively without negatively influencing the typical properties of porous concrete products.

The present invention relates to the novel use of an organic additive which is known per se in the production of porous concrete.

Porous concrete (formerly also referred to as gas concrete) is a comparatively light, porous mineral building material based on lime, lime cement or cement mortar which is subjected to steam curing in priciple.

According to the definition of the term “concrete”, porous concrete is not such a material since it does not contain any aggregates. Porous concrete is characterized by a large amount of large-volume air pores and is produced mainly from the raw materials quicklime, cement and silica sand. Here, the finely milled sand (quartz flour), some of which can also be replaced by fly ash, is mixed together with quicklime and cement in a ratio of 1:1:4 with addition of water to give a typical mortar mixture. A small amount of aluminum powder is finally stirred into this finished suspension and this mortar mixture is poured into tubs. There, hydrogen gas is evolved due to the amount of finely divided metallic aluminum in the alkali mortar suspension, as a result of which numerous small gas bubbles are formed and foam the gradually stiffening mixture. After the final volume has been reached after about 15-50 minutes, blocks having a length of from 3 to 8 m and a width of from 1 to 1.5 m and a height of from 50 to 80 cm are generally obtained. These blocks in the “cake-solid” state are cut by means of wires to the desired block or component sizes. Curing in special steam pressure vessels, known as autoclaves, at temperatures of from 180° C. to 200° C. under a steam pressure of from 10 to 12 bar gives the material its final properties after from 6 to 10 hours.

The addition of varying amounts of aluminum enables the density of porous concrete to be set within wide ranges, with customary products having densities of from <350 kg/m³ to 750 kg/m³. Owing to its low density compared to conventional concrete, porous concrete has a low strength but a low thermal conductivity which produces an excellent thermal insulation effect.

The actual production of porous concrete is characterized by two main reaction phases: in the first phase, the so-called green porous concrete is produced and brought to the cuttable green strength. As a result of the constituents lime and cement, strongly exothermic reactions take place in the hydration of the lime (CaO), which together with other reactions leads to stiffening of the dispersion. The duration of stiffening can range from just a few minutes in the case of lime-rich formulations to six hours in the case of formulations which are low in lime and at the same time rich in cement. The rate of stiffening is determined mainly by the proportion of lime in the formulation, the total proportion of binder, the water/solids ratio, the temperature and the increase in temperature, the alkalinity of the lime or of the cement and also possible other binders and finally by the desired density.

In the second reaction phase, curing of the cake-solid raw material occurs. As indicated in general terms above, this second phase is carried out in autoclaves under hydrothermal pressure conditions, with silicate constituents being dissolved and reacting with the likewise dissolved CaO to form various calcium silicate hydrate phases until the lime (CaO) is consumed. Since, however, SiO₂ continues to be dissolved, further and very SiO₂-rich phases are formed from the calcium silicate hydrate phases which are already in solution.

The porous concrete components produced in this way can, like steel-reinforced concrete parts, have reinforcement in order to be able to withstand tensile forces. The best-known porous concrete components are finished components which are used as wall, ceiling and roof boards and provide high thermal insulation. However, porous concrete is also used in the form of masonry bricks and other finished components which are characterized by an extremely low density. The easy and versatile processability of porous concrete material makes it suitable, first and foremost, for use in individualized interior outfitting.

The known porous concrete production processes are fundamentally very energy-intensive processes, which can be attributed to a considerable extent to the second reaction phase, namely the autoclave phase.

There is therefore a continual search for improved measures in order to make porous concrete production even cheaper and, in particular, less energy-consuming. This was attempted in the past mainly by means of further additives, naturally without the typical properties of the cured porous concrete, namely its compressive strength and its thermal insulation capability, being allowed to be adversely affected.

Additives which have a positive effect on the processability of building chemical compositions and/or the properties of the product produced therewith are adequately known. Reference may at this point be made to additives for hydraulically curing building materials such as concretes, mortars and gypsum class of compositions, as are described, for example, in DE 44 34 010 C2, DE-OS 20 49 114, EP-A 214 412, DE-PS16 71 017, EP 0 736 553 B1 and EP 1 189 955 B1, with the compounds mentioned as additives in these documents being incorporated by reference into the present disclosure.

It was an object of the present invention to provide a novel additive by means of which, firstly, porous concrete having at least the excellent properties known hitherto can be produced and, secondly, by means of which the standard production process can also be carried out significantly more cheaply.

This object has been achieved by the use of an organic additive having water-reducing, dispersing and/or flowability-increasing properties for the production of porous concrete.

It has surprisingly been found in the novel inventive use of the organic additives that the production process for porous concrete can be carried out significantly more cheaply in terms of the associated energy consumption since, in particular, smaller amounts of water can be used due to the water-reducing, dispersing and/or flowability-increasing properties of the organic additives used. In contrast to previous processes, the second reaction phase in particular, i.e. the autoclave process, is positively influenced thereby since only small amounts of water now have to be removed from the starting matrix in the green, solid state, which is naturally associated with a lower energy consumption. In addition, the use according to the present invention results in the foaming process and the pore distribution being more homogeneous overall and the cell structure of the pores being more uniform. These advantages were not able to be foreseen in their totality.

The use according to the invention is characterized, in particular, by a preferred additive which is at least one representative of the group consisting of polycondensation products based on naphthalenesulfonic or alkylnaphthalenesulfonic acids, melamine-formaldehyde resins containing sulfonic acid groups and copolymers based on unsaturated monocarboxylic or dicarboxylic acid derivatives and oxyalkylene glycol alkenyl ethers.

According to the invention, condensation products which are present in the form of salts of water-soluble napthalenesulfonic acid-formaldehyde condensates are particularly suitable additives. The molar ratio of formaldehyde to naphthalenesulfonic acid should be from 1:1 to 10:1, more preferably from 1.1:1 to 5:1 and most preferably from 1.2:1 to 3:1. However, condensed additives which contain amino-s-triazine, formaldehyde and sulfite as building blocks in a molar ratio of 1:1.1-10.0:0.1-2 and more preferably 1:1.3-6.0:0.3-1.5 are also possible. Typical amino-s-triazines are melamine and guanamines, e.g. benzoguanamine or acetoguanamine. For information about these condensation products and suitable processes for preparing them, reference may be made, in particular, to DE 44 34 010 C2, which is incorporated by reference into the present disclosure.

Preferred additives for the purposes of the present invention are, inter alia, compounds which contain at least 2 but preferably 3 and particularly preferably 4of the structural units a), b), c) and d). The first structural unit a) is a monocarboxylic or dicarboxylic acid derivative having the general formula Ia, Ib or Ic.

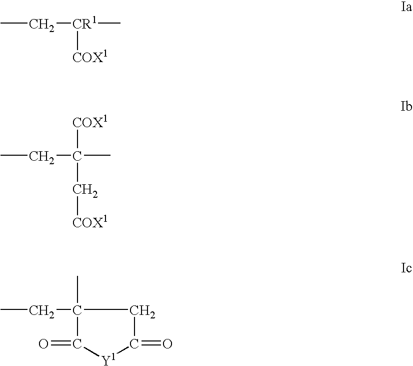

In the monocarboxylic acid derivative Ia, R¹ is hydrogen or an aliphatic hydrocarbon radical having from 1 to 20 carbon atoms, preferably from 1 to 10 carbon atoms, and is most preferably a methyl group. X¹ in the structures Ia and Ib is —OM¹ₐ and/or —O—(CₘH₂ₘO)ₙ—R² or —NH—(CₘH₂ₘO)ₙ—R², where M¹, a, m, n and R² are as defined below:

M¹ is hydrogen, a monovalent or divalent metal cation, ammonium, an organic amine radical and a=½ or 1 depending on whether M¹ is a monovalent or divalent cation. As organic amine radicals, preference is given to using substituted ammonium groups derived from primary, secondary or tertiary C₁₋₂₀-alkylamines, C₁₋₂₀-alkanolamines, C₅₋₈-cycloalkylamines and C₆₋₁₄-arylamines. Examples of the corresponding amines from which these radicals are derived are methylamine, dimethylamine, trimethylamine, ethanolamine, diethanolamine, triethanolamine, methyldiethanolamine, cyclohexylamine, dicyclohexylamine, phenylamine, diphenylamine in the protonated (ammonium) form. Sodium, potassium, calcium and magnesium are preferred monovalent or divalent metal ions M¹.

R² is hydrogen, an aliphatic hydrocarbon radical having from 1 to 20 carbon atoms, a cycloaliphatic hydrocarbon radical having from 5 to 8 carbon atoms, an aryl radical which has from 6 to 14 carbon atoms and may be substituted, m=2 to 4 and n=0 to 200. The aliphatic hydrocarbons can be linear or branched and saturated or unsaturated. Preferred cycloalkyl radicals are cyclopentyl or cyclohexyl radicals, and preferred aryl radicals are phenyl or naphthyl radicals which may, in particular, be substituted by hydroxyl, carboxyl or sulfonic acid groups.

In place of or together with the dicarboxylic acid derivative of the formula Ib, the structural unit a) (monocarboxylic or dicarboxylic acid derivative) can also be present in cyclic form corresponding to the formula Ic, where Y may be Y═O (acid anhydride) or NR² (acid imide) with the above meanings for R².

The second structural unit b) corresponds to the formula II

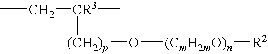

and is derived from oxyalkylene glycol alkenyl ethers in which m, n and R² are as defined above. R³ is hydrogen or an aliphatic hydrocarbon radical which has from 1 to 5 carbon atoms and may likewise be linear or branched or unsaturated, p can be from 0 to 3.

In the preferred embodiments, m in the formulae Ia, Ib and II is 2 and/or 3, so that polyalkylene oxide groups derived from polyethylene oxide and/or polypropylene oxide are present. In a further preferred embodiment, p in the formula II is 0 or 1, i.e. vinyl and/or allyl polyalkoxylates are present.

The third structural unit c) corresponds to the formula IIIa or IIIb

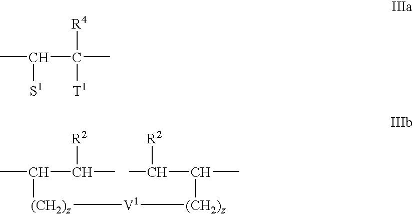

In the formula IIIa, R⁴ can be H or CH₃ depending on whether acrylic or methacrylic acid derivatives are present. S¹ can be —H, —COOM¹ₐ or —COOR⁵, where a and M¹ are as defined above and R⁵ can be an aliphatic hydrocarbon radical having from 3 to 20 carbon atoms, a cycloaliphatic hydrocarbon radical having from 5 to 8 carbon atoms or an aryl radical having from 6 to 14 carbon atoms. The aliphatic hydrocarbon radical can likewise be linear or branched, saturated or unsaturated. The preferred cycloaliphatic hydrocarbon radicals are again cyclopentyl or cyclohexyl radicals and the preferred aryl radicals are phenyl or naphthyl radicals. If T¹=COOR⁵, S¹=COOMₐ or —COOR⁵. If T¹ and S¹=COOR⁵, the corresponding structural units are derived from dicarboxylic esters.

Apart from these ester structures, the structural units c) can also have other hydrophobic elements. These include the polypropylene oxide or polypropylene oxide-polyethylene oxide derivatives in which

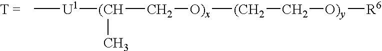

x is in the range from 1 to 150 and y is from 0 to 15. The polypropylene oxide(-polyethylene oxide) derivatives can here be linked via a group U¹ to the ethyl radical of the structural unit c) in accordance with the formula IIIa, where U¹ can be —CO—NH—, —O— or —CH₂—O—. This results in the corresponding amide, vinyl or allyl ethers of the structural unit corresponding to the formula IIIa. R⁶ can have one of the meanings of R² (for meanings of R², see above) or be

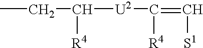

where U²=—NH—CO—, —O— or —OCH²— and S¹ is as defined above. These compounds are polypropylene oxide(-poly-ethylene oxide) derivatives of the bifunctional alkenyl compounds corresponding to the formula IIIa.

As further hydrophobic element, the compounds can, in accordance with the formula IIIa, contain polydimethyl-siloxane groups, corresponding to T¹=—W¹—R⁷ in the formula IIIa.

### Here, W¹ is

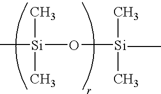

(hereinafter referred to as polydimethylsiloxane group), R⁷ can have one of the meanings of R² and r can be in the range from 2 to 100.

The polydimethylsiloxane group can not only be bound directly to the ethylene radical in accordance with the formula IIIa but can also be bound via the group

—CO—[NH—(CH₂)₃]ₛ—W¹—R⁷ or —CO—O(CH₂)_{z}—W¹—R⁷,

where R⁷ preferably has one of the meanings of R² and s=1 or 2 and z=0 to 4. R⁷ can also be

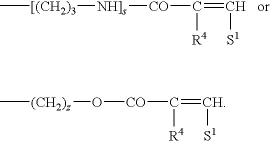

Here, the corresponding bifunctional ethylene compounds corresponding to the formula IIIa which are linked to one another via the corresponding amide or ester groups and in which only one ethylene group has been copolymerized are present.

A similar situation applies to the compounds of the formula IIIa in which T¹=(CH₂)_{z}—V¹—(CH₂)_{z}—CH═CH—R², where z=0 to 4, where V¹ can be either a polydimethylsiloxane radical W¹ or a —O—CO—C₆H₄—CO—O— radical and R² is as defined above. These compounds are derived from the corresponding dialkenyl phenyldicarboxylic ester or dialkenylpolydimethylsiloxane derivatives.

Within the scope of the present invention, it is also possible for not only one but both ethylene groups of the bifunctional ethylene compounds to have been copolymerized. This corresponds essentially to the structural units corresponding to the formula IIIb

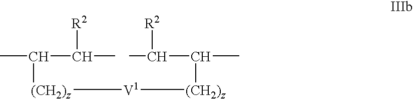

in which R², V¹ and z have the meanings described above.

The fourth structural unit d) is derived from an unsaturated dicarboxylic acid derivative of the general formula IVa and/or IVb

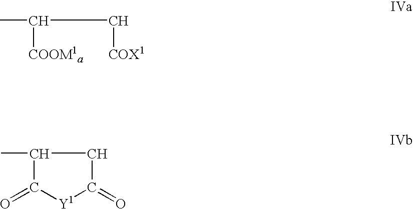

where a, M¹, X¹ and Y¹ are as defined above. Typical representatives of this unsaturated dicarboxylic acid derivative are derived from maleic acid, fumaric acid and their monovalent or divalent metal salts, e.g. the Na, K, Ca or NH₄ salt, or from salts having an organic amine radical.

Preference is given to the copolymers comprising from 51 to 95 mol % of structural units of the formula Ia and/or Ib and/or Ic, from 1 to 48.9 mol % of structural units of the formula II, from 0.1 to 5 mol % of structural units of the formula IIIa and/or IIIb and from 0 to 47.9 mol % of structural units of the formula IVa and/or IVb.

The additive used according to the invention is preferably composed of the structural units a) and b) and, if desired, c). The additive in the form of a copolymer particularly preferably comprises from 55 to 75 mol % of structural units of the formula Ia and/or Ib, from 19.5 to 39.5 mol % of structural units of the formula II, from 0.5 to 2 mol % of structural units of the formula IIIa and/or IIIb and from 5 to 20 mol % of structural units of the formula IVa and/or IVb.

In a preferred embodiment, the additive used according to the invention in the form of a copolymer additionally contains up to 50 mol %, in particular up to 20 mol %, based on the sum of the structural units of the formulae I, II, III and IV, structures based on monomers based on vinyl or (meth)acrylic acid derivatives such as styrene, α-methylstyrene, vinyl acetate, vinyl propionate, ethylene, propylene, isobutene, hydroxyalkyl(meth)acrylates, acrylamide, methacrylamide, N-vinylpyrrolidone, allylsulfonic acid, methallylsulfonic acid, vinylsulfonic acid, vinylphosphonic acid, AMPS, methyl methacrylate, methyl acrylate, butyl acrylate, allylhexyl acrylate, etc.

The number of repeating structural units in the copolymers used in each case is not restricted. However, it has been found to be particularly advantageous to set average molecular weights of from 500 to 1 000 000 g/mol, more preferably from 1000 to 100 000 g/mol.

The present special use is characterized by, in particular, the respective additive being added to a porous concrete base mixture comprising lime, a hydraulic binder, preferably in the form of cement, sand, in particular silica sand, and, if appropriate, further components selected from among anhydrite and fly ash. Here, the porous concrete base mixture can naturally also contain other components and additives according to the respective application, as long as the composition of the pore concrete base mixture does not have an adverse effect on the claimed use of the organic additives described.

An important role in the production of porous concrete is naturally played by the gas-producing component which in the majority of cases is aluminum powder. The use according to the invention of the organic additive is not at all restricted to a particular time of addition. This means that the additive according to the present invention can be used both in the first main reaction phase, i.e. in the production of the green solid matrix, and directly before commencement of gas evolution. The present invention provides, as a preferred variant, the addition of the additive to a porous concrete base composition which already contains the gas-producing component and preferably aluminum powder.

The amount of additive added is also not subject to any actual restriction in the present case. Only the aim to be achieved by addition of the organic additive and economic aspects limit the amount added. For this reason, the present invention provides for the additive preferably to be added in amounts of from 0.01 to 10% by weight, preferably in amounts of from 0.1 to 5% by weight and most preferably in an amount of from 0.2 to 1.0% by weight, in each case based on the weight of the mineral binder, to the unfoamed porous concrete base mixture which is, in particular, free of make-up water. The additive can, for the purposes of the present invention, be used both in the solid state and in the liquid state. Since, however, liquid phases are preferred in porous concrete production in the majority of cases, it is advisable also to add the additives mentioned in liquid form and subsequently to mix the resulting raw mixture thoroughly.

Finally, a further preferred aspect is that porous products having a density of ≦1000 kg/m³, preferably in the range from 300 to 700 kg/m³ and particularly preferably in the range from 350 to 550 kg/m³, are obtained with the use claimed.

In summary, novel porous concrete grades which can be obtained by means of a production process which has significant advantages in terms of energy and costs are made accessible by the proposed novel use of organic additives which are known per se from building chemistry. This is accompanied by a savings potential in respect of the raw materials used (in particular water) and the associated significantly lower energy consumption, in particular in the autoclave phase.

The following examples illustrate the advantages of the use according to the invention.

### EXAMPLES

### Use Example 1

### Base Formulation for Porous Concrete

| | |
|---|---|
| Sand (quartz flour) | 665 g |
| Quicklime | 103 g |
| Cement | 160 g |
| Anhydrite | 39 g |
| White hydrated lime | 32 g |
| Aluminum powder | 1 g |
| Additive having a plasticizing | depending on |
| action | requirements |
| Make-up water | depending on |
| | requirements |

Mixing procedure and methods of determination:

The raw materials were weighed out to a precision of +/−0.05 g on a digital laboratory balance. The temperature of the water to be added was set to 40° C. before introduction into the mixer. The raw materials were combined in the following order:

TABLE 1

| | | Mixing time in |
|---|---|---|
| | Component | [sec] |
| 1. | Introduce water | — |
| | and additive | |
| 2. | Sand and white | 60 |
| | hydrated lime | |
| 3. | Quicklime | 60 |
| 4. | Cement and | 45 |
| | anhydrite | |
| | Determination of consistency using | |
| | 50/50 mm cylinder | |
| 5. | Aluminum powder | 20 |

Table 2 below shows the water-reducing effect for various types of plasticizer which can be added according to the invention compared to a mixture without additive. The consistency of the raw mixture with addition of plasticizer is improved at the significantly lower water values.

TABLE 2

| Plasticizer (additive | Amount added | | | | | |
|---|---|---|---|---|---|---|
| according to the | [% based on | W/dry mortar | Slump in [cm] after | | | Density |
| Invention | dry mortar] | values | 5 min | 15 min | 30 min | [g/cm³] |
| none (comparison) | — | 0.70 | 21.0 | 20.2 | 18.7 | 0.65 |
| Melment L 10/40% | 0.40 | 0.45 | 21.5 | 20.9 | 19.9 | 0.65 |
| Liquiment N 40% | 0.40 | 0.45 | 21.8 | 21.5 | 18.9 | 0.64 |
| Melflux 2424 L/50% ND | 0.30 | 0.40 | 22.3 | 21.0 | 20.3 | 0.63 |
| Melflux 2062 L/47% ND | 0.30 | 0.40 | 24.1 | 24.0 | 23.9 | 0.62 |
| Melflux 2500 L/45% ND | 0.30 | 0.40 | 24.2 | 24.1 | 23.7 | 0.63 |

W/dry mortar = ratio of water to dry mortar
Melment ®, Liquiment ® and Melflux ® are trademarks of Degussa Construction Polymers GmbH.

The last column of table 2 shows the densities of the porous concrete composition after foaming. The results obtained at a reduced water content (see W/dry mortar values) and a constant amount of aluminum demonstrate the positive effect of the dispersants added according to the invention on the foaming process, i.e. the effectiveness of the aluminum powder used in respect of the foaming process is increased despite a reduced amount of water.

1-6. (canceled)

7. A composition comprising a porous concrete base material and a sufficient amount of an organic additive having at least one of water-reducing, dispersing or flowability-increasing properties to yield a porous concrete.

8. A composition according to claim 7, wherein the organic additive comprises at least one of a polycondensation products based on naphthalenesulfonic acid or alkylnaphthalenesulfonic acid, a melamine-formaldehyde resin containing sulfonic acid groups, and a copolymer based on unsaturated monocarboxylic or dicarboxylic acid derivatives and a oxyalkylene glycol alkenyl ether.

9. A composition according to claim 7, wherein the porous concrete base material contains lime, a hydraulic binder, and sand.

10. A composition according to claim 7, further comprising a gas-producing component.

11. A composition according to claim 7, wherein the porous concrete base composition comprises a mineral binder, and said additive is present in an amount of from 0.01 to 10% by weight based on the weight of the mineral binder.

12. A composition according to claim 11, wherein said amount is from 0.1 to 5% by weight.

13. A composition according to claim 12, wherein said amount is from 0.2 to 1.0% by weight.

14. A composition according to claim 11, wherein the composition is preferably free of make-up water.

15. A composition according to claim 7, wherein the porous concrete product, when cured, has a density of ≦1000 kg/m³.

16. A composition according to claim 15, wherein the porous concrete product has a density of from 300 to 700 kg/m³.

17. A composition according to claim 16, wherein the density ranges from 350 to 550 kg/m³.

18. A composition according to claim 9, wherein the hydraulic binder is cement.

19. A composition according to claim 10, wherein the gas-producing component is aluminum powder.

20. A method comprising preparing a composition comprising a porous concrete base material and a sufficient amount of an organic additive having at least one of water-reducing, dispersing or flowability-increasing properties to yield a porous concrete admixture.

21. A method comprising curing the porous concrete admixture of claim 21 to yield a porous concrete having a density of less than or equal to 1000 kg/m³.

22. A composition according to claim 9, wherein the porous concrete base material further comprises anhydrite or fly ash.

23. A composition according to claim 9, wherein said sand is silica sand.

24. A method comprising preparing the composition by adding an organic additive having at least one of water-reducing, dispersing or flowability-increasing properties to a porous concrete base material that already contains the gas-producing component, wherein the additive is added to unfoamed porous concrete base mixture.

25. The method of claim 24, wherein the unfoamed porous concrete base mixture is free of make-up water.
